(19) United States
(12) Patent Application Publication
(10) Pub. No.: US 2018/0342130 A1
(43) Pub. Date: Nov. 29, 2018

(54) ELECTRONIC GAME CREDIT

(71) Applicant: Walmart Apollo, LLC, Bentonville, AR (US)

(72) Inventors: Steven Lewis, Bentonville, AR (US); Nicholaus Adam Jones, Fayetteville, AR (US)

(21) Appl. No.: 15/985,021

(22) Filed: May 21, 2018

Related U.S. Application Data
(60) Provisional application No. 62/511,712, filed on May 26, 2017.

(51) Int. Cl. G07F 17/32; G06Q 20/32; G06Q 30/02

(52) U.S. Cl. CPC G07F 17/3255; G06Q 30/0209; G06Q 20/3224; G07F 17/3206

(57) ABSTRACT

Methods and systems for providing electronic game credit for an electronic game application in response to detecting completion of a task may be provided. A method may include determining, at an entity host device, that a mobile device corresponding to a user is present at an entity location. The method may further include transmitting, from the entity host device to the mobile device at the entity location, the task for the user to complete at the entity location. The method may also include detecting, at the entity host device, that the user has completed the task at the entity location. The method may additionally include, in response to detecting that the user has completed the task at the entity location, assigning, at the entity host device, the electronic game credit to an electronic game credit record corresponding to the user.

### CROSS REFERENCE TO RELATED APPLICATION[S]

This application claims the benefit of U.S. Provisional application No. 62/511,712, filed May 26, 2017 and titled “Electronic Game Credit,” the contents of which are incorporated herein in their entirety.

### TECHNICAL FIELD

The technical field may generally relate to electronic game credit, and more particularly to providing electronic game credit for an electronic game application in response to detecting completion of a task.

### BACKGROUND

An entity (e.g., company or business) may have tasks which need to be completed in order for the company or business to operate more smoothly. For example, a store may have a number of tasks which need to be completed, such as stocking and straightening shelves, and may hire one or more employees or associates to complete such tasks. There may be a large number of tasks which need to be completed at the store and the employees or associates may not be properly incentivized to complete the tasks. Further, there may not be enough employees or associates at the store to complete all of the tasks in a timely manner. Thus, there may be a need for methods and systems which provide various incentives for the tasks to be completed.

### BRIEF SUMMARY

In an embodiment, a method for providing electronic game credit for an electronic game application in response to detecting completion of a task may include determining, at an entity host device, that a mobile device corresponding to a user is present at an entity location. The method may further include transmitting, from the entity host device to the mobile device at the entity location, the task for the user to complete at the entity location. The method may also include detecting, at the entity host device, that the user has completed the task at the entity location. Additionally, the method may also include, in response to detecting that the user has completed the task at the entity location, assigning, at the entity host device, the electronic game credit to an electronic game credit record corresponding to the user. Moreover, the method may include linking an entity user ID corresponding to the user with an electronic game application ID corresponding to the user. Furthermore, the method may include transmitting the electronic game credit in the electronic game credit record from the entity host device to an electronic game application host server associated with the electronic game application based on the linking of the entity user ID and the electronic game application ID.

In an implementation, the method may include transmitting, from the entity host device to the electronic game application host server, an electronic notification indicating that the user can receive electronic game credit for the electronic game application upon completing the task. The electronic game credit in the electronic game credit record may be transmitted from the entity host device to the electronic game application host server in response to detecting that the mobile device corresponding to the user is no longer present at the entity location. The entity host device may be at least one of an entity host server and a home office device and the electronic game credit is an incentive defined via at least one of the entity host server and the home office device. The incentive may be created to prioritize the task. The method may also include receiving an electronic game preference from the user identifying an electronic game application preferred by the user for which the electronic game credit is assigned in response to detecting that the user has completed the task at the entity location.

In an implementation, the method may further include auditing a random sample of electronic game credits assigned to users to ensure that tasks for which the electronic game credits were assigned were completed. The method may also include, in response to determining that the task was not completed, removing the user from an electronic game credit program. The method may additionally include comparing results from a same task completed by different users to determine if the task was actually completed. The entity location may be at least one of a retail store location and a distribution center and the task may be at least one of a retail store task and a distribution center task. The user may be at least one of a retail store associate and a retail store customer. The completion of the retail store task by the retail store customer at the retail store location may offload the retail store task from a retail store associate task list.

In an embodiment, a system for providing electronic game credit for an electronic game application in response to detecting completion of a task may be provided. The system may include an entity host device in communication with a mobile device corresponding to a user. The entity host device may be configured to determine whether the mobile device corresponding to the user is present at an entity location. The entity host device may be further configured to transmit, to the mobile device at the entity location, the task for the user to complete at the entity location. The entity host device may be additionally configured to detect, at the entity host device, that the user has completed the task at the entity location. The entity host device may also be configured to, in response to detecting that the user has completed the task at the entity location, assign the electronic game credit to an electronic game credit record corresponding to the user. Moreover, the entity host device may be configured to link an entity user ID corresponding to the user with an electronic game application ID corresponding to the user. Furthermore, the entity host device may be configured to transmit the electronic game credit in the electronic game credit record to an electronic game application host server associated with the electronic game application based on the linking of the entity user ID and the electronic game application ID.

In an implementation, the entity host device may be further configured to transmit, to the electronic game application host server, an electronic notification indicating that the user can receive electronic game credit for the electronic game application upon completing the task. The electronic game credit in the electronic game credit record may be transmitted from the entity host device to the electronic game application host server in response to detecting that the mobile device corresponding to the user is no longer present at the entity location. The entity host device may be at least one of an entity host server and a home office device and the electronic game credit is an incentive defined via at least one of the entity host server and the home office device. The incentive may be created to prioritize the task. The entity host device may also be configured to receive an electronic game preference from the user identifying an electronic game application preferred by the user for which the electronic game credit is assigned in response to detecting that the user has completed the task at the entity location. The entity host device may additionally be configured to audit a random sample of electronic game credits assigned to users to ensure that tasks for which the electronic game credits were assigned were completed.

In an embodiment, a computer program product residing on a computer-readable storage medium may have a plurality of instructions stored thereon, which, when executed by a processor, may cause the processor to perform operations for providing electronic game credit for an electronic game application in response to detecting completion of a task. The operations may include determining, at an entity host device, that a mobile device corresponding to a user is present at an entity location. The operations may further include transmitting, from the entity host device to the mobile device at the entity location, the task for the user to complete at the entity location. The operations may also include detecting, at the entity host device, that the user has completed the task at the entity location. The operations may additionally include, in response to detecting that the user has completed the task at the entity location, assigning, at the entity host device, the electronic game credit to an electronic game credit record corresponding to the user. Moreover, the operations may include linking an entity user ID corresponding to the user with an electronic game application ID corresponding to the user. Furthermore, the operations may include transmitting the electronic game credit in the electronic game credit record from the entity host device to an electronic game application host server associated with the electronic game application based on the linking of the entity user ID and the electronic game application ID.

In an embodiment, a computing system for providing electronic game credit for an electronic game application in response to detecting completion of a task may include one or more processors. The one or more processors may be configured to determine, at an entity host device, that a mobile device corresponding to a user is present at an entity location. The one or more processors may also be configured to transmit, from the entity host device to the mobile device at the entity location, the task for the user to complete at the entity location. The one or more processors may additionally be configured to detect, at the entity host device, that the user has completed the task at the entity location. Moreover, the one or more processors may be configured to, in response to detecting that the user has completed the task at the entity location, assign, at the entity host device, the electronic game credit to an electronic game credit record corresponding to the user. The one or more processors may be further configured to link an entity user ID corresponding to the user with an electronic game application ID corresponding to the user. Furthermore, the one or more processors may be configured to transmit the electronic game credit in the electronic game credit record from the entity host device to an electronic game application host server associated with the electronic game application based on the linking of the entity user ID and the electronic game application ID.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts an example system that can execute implementations of the present disclosure;

FIG. 2 illustrates an example process for providing electronic game credit in accordance with the present disclosure;

FIG. 3 depicts an example system for providing electronic game credit in accordance with the present disclosure;

FIG. 4 also depicts an example process for providing electronic game credit in accordance with the present disclosure; and

FIG. 5 also depicts an example process for providing electronic game credit in accordance with the present disclosure.

### DETAILED DESCRIPTION

### Overview

An entity (e.g., company or business) may wish to incentivize employees, associates, or others to complete tasks for the entity. One way to incentivize task completion may be to provide electronic game credit for completion of a task. Systems and methods for providing electronic game credit for an electronic game application in response to detecting completion of a task may be provided in the present disclosure.

The systems and methods described in the present disclosure may enable users (e.g., employees, associates, customers, or other users, etc.) to collect electronic game credit for completing tasks while at work at the entity (e.g., a store) or while visiting the entity (e.g., a store). Electronic games that require credits to play may be ubiquitous in the market place and many people may play them on various computing devices such as mobile phones or tablets. An incentive of acquiring electronic game credit for a game may encourage users (e.g., employees, associates, customers, etc.) to be more effective and efficient in finding and completing tasks for the entity.

For example, an employee or associate at a store may be provided a task list which may include a number of tasks for the employee or associate to complete at the store. Rewards such as electronic game credits may be given for the task completion. The rewards and tasks may be paired with the associate's preference of electronic games, or may be the same for all the associates. As the associate performs each task in the store, the associate may compile electronic game credits for various electronic games. Various mechanisms may be used to ensure that the associate is performing the task and not cheating. Further, when the associate logs out of or otherwise leaves work either to go home or during breaks, the incentive may be pushed to an electronic game which may be correlated with a login for the associate. In this way, the associate may be given credit to use in the electronic game.

In an implementation others besides employees or associates of the entity, such as customers, may also earn electronic game credits through performing tasks for the entity. For example, a customer may be provided electronic game credit for completing a survey about a store, but other tasks are within the scope of the present disclosure. An electronic game may display a message (e.g., when the customer starts the game) or the electronic game may display a notification that there is a reward for completing specific tasks for the entity (e.g., at a store). The rewards (e.g., electronic game credits) may be based on the importance of the task as well as the time it would take to perform the task. After performing a task, the customer may receive electronic game credit for the electronic game through which the customer was notified of the task.

Various mechanisms may be used to ensure that the customer is performing the task and is not cheating. In an implementation, if a customer/user is known to have either not completed the task or the task was done improperly, that customer/user may not get more opportunities for earning electronic game credit for performing tasks. For example, the same task may be given to multiple users and the results may be compared.

In an implementation, the entity may partner with an existing electronic game developer to provide signage or advertising to the electronic game developer in exchange for providing electronic game credit for the developer's games to users as instructed by the entity. The entity may also pay the developer for electronic game credits. In an implementation, the entity may develop an electronic game and make it available to the public such that the entity may control electronic game credits for the game. Incentives may be created or administered at the home office or store of the entity, which may help in the prioritization of tasks. In an implementation, a home office may be a centralized headquarters of an entity or business. An administrator at the home office may input tasks and incentives in order to prioritize some tasks over others. In an implementation, a store manager, for example, may budget an amount of incentives in order to steer the user to tasks that need to be completed.

Using the techniques and features described in the present disclosure, an entity may offload tasks from task lists for its employees, may provide incentives for customers to come to the entity (e.g., a store) and enhance business and sales, allow for more work to be completed for the entity, increase an employee or associate's productivity at work, and/or allow for better prioritization of tasks.

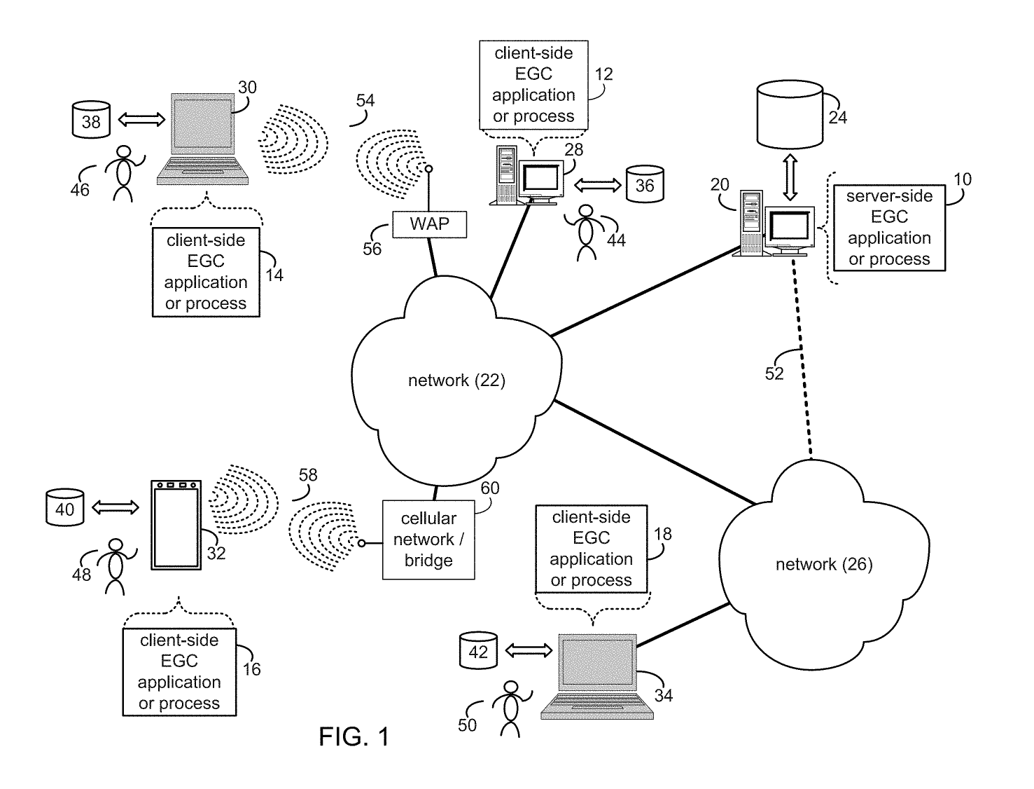

Referring to FIGS. 1 & 2, there is shown a server application 10 and client applications 12, 14, 16, and 18. Server application 10 and/or one or more of client applications 12, 14, 16, and/or 18 may execute one or more processes configured to carry out one or more of the features described herein. Server application 10 may be referred to as a process configured to carry out one or more of the features described herein, such as electronic game credit (EGC) process 10. Further, one or more of client applications 12, 14, 16, and 18 may be referred to as a process configured to carry out one or more of the features described herein, such as electronic game credit (EGC) processes 12, 14, 16, and/or 18.

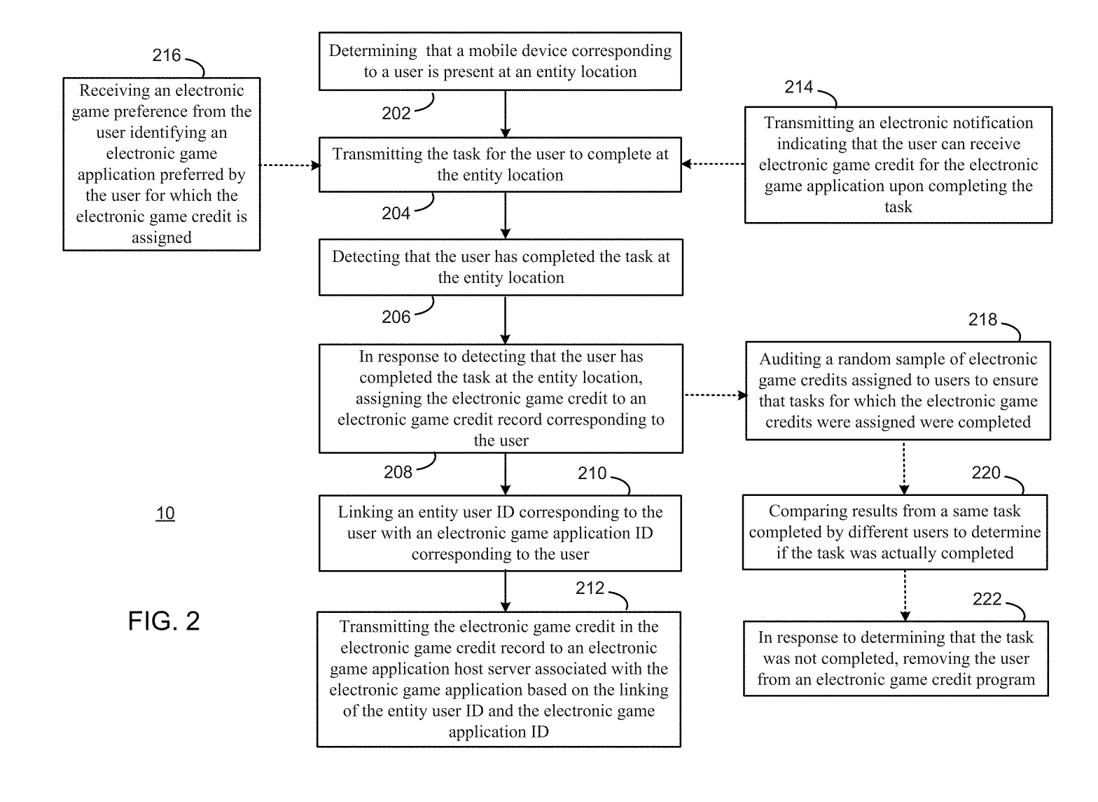

Referring now to FIG. 2, an example EGC process 10 is shown. EGC process 10 may determine (202) that a mobile device corresponding to a user is present at an entity location. EGC process 10 may further include transmitting (204) the task for the user to complete at the entity location. EGC process 10 may also include detecting (206) that the user has completed the task at the entity location. Further, EGC process 10 may, in response to detecting that the user has completed the task at the entity location, assign (208) the electronic game credit to an electronic game credit record corresponding to the user. EGC process 10 may additionally link (210) an entity user ID corresponding to the user with an electronic game application ID corresponding to the user. Moreover, EGC process 10 may transmit (212) the electronic game credit in the electronic game credit record to an electronic game application host server associated with the electronic game application based on the linking of the entity user ID and the electronic game application ID.

The EGC process may be a server-side process (e.g., server-side EGC process 10), a client-side process (e.g., client-side EGC process 12, client-side EGC process 14, client-side EGC process 16, or client-side EGC process 18), or a hybrid server-side/client-side process (e.g., a combination of server-side EGC process 10 and one or more of client-side EGC processes 12, 14, 16, 18).

### System Overview

Referring to FIG. 1, server-side EGC process 10 may reside on and may be executed by server computer 20, which may be in communication with network 22 (e.g., the Internet or a local area network). Examples of server computer 20 may include, but are not limited to: a personal computer, a server computer, a series of server computers, a mini computer, and/or a mainframe computer. The server computer 20 may be a distributed system and the operations of the server computer 20 may execute on one or more processors, simultaneously and/or serially. For example, server computer 20 may be a symbolic representation of a cloud computing site, cloud environment, or cloud platform running multiple servers, computers, or virtual machines. Server computer 20 may execute one or more operating systems, examples of which may include but are not limited to: Microsoft Windows Server™; Novell Netware™; Redhat Linux™, Unix, or a custom operating system, for example.

For example, server computer 20 may be a symbolic representation of a cloud-based customer savings redemption system or server suitable for performing the operations described in the present disclosure. In an implementation, server computer 20 may be a cloud-based customer savings redemption system or server which may include, store, run, and/or execute EGC process 10. The cloud-based customer savings redemption system or server may be part of a network of servers and other computing devices administered by a company or business that uses EGC process 10, such as a retailer or physical store having employees or associates.

The instruction sets and subroutines of server-side EGC process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a solid state storage device; a RAID array; a random access memory (RAM); and a read-only memory (ROM).

Server computer 20 may execute a web server application that allows for access to server computer 20 (via network 22) using one or more protocols, examples of which may include but are not limited to HTTP (i.e., HyperText Transfer Protocol). Network 22 may be in communication with one or more secondary networks (e.g., network 26), examples of which may include but are not limited to: a local area network; a wide area network; or an intranet, for example.

Client-side EGC processes 12, 14, 16, 18 may reside on and may be executed by client electronic devices 28, 30, 32, and/or 34 (respectively), examples of which may include but are not limited to personal computer 28, a television with one or more processors embedded therein or coupled thereto (not shown), laptop computer 30, data-enabled mobile telephone or smartphone 32, notebook computer 34, a tablet (not shown), and a personal digital assistant (not shown), for example. Client electronic devices 28, 30, 32, and/or 34 may each be in communication with network 22 and/or network 26 and may each execute an operating system, examples of which may include but are not limited to Apple iOS™, Microsoft Windows™, Android™, Redhat Linux™, or a custom operating system.

In an implementation, one or more of client electronic devices 28, 30, 32, and/or 34 may be associated with an associate or customer of the entity (e.g., company or business) that uses or implements one or more of EGC process 10, 12, 14, 16, and/or 18 such as a retailer or physical store having customers. For example, data-enabled mobile telephone 32 may be a mobile device such as a smartphone associated with a customer.

The instruction sets and subroutines of client-side EGC processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; solid state storage devices; RAID arrays; random access memories (RAM); read-only memories (ROM); compact flash (CF) storage devices; secure digital (SD) storage devices; and memory stick storage devices.

Client-side EGC processes 12, 14, 16, 18 and/or server-side EGC process 10 may be processes that run within (i.e., are part of) a cloud computing site, cloud computing application, cloud platform, or cloud environment. Alternatively, client-side EGC processes 12, 14, 16, 18 and/or server-side EGC process 10 may be stand-alone applications that work in conjunction with the cloud computing site, cloud computing application, cloud platform, or cloud environment. One or more of client-side EGC processes 12, 14, 16, 18 and server-side EGC process 10 may interface with each other (via network 22 and/or network 26).

Users 44, 46, 48, 50 may access server-side EGC process 10 directly through the device on which the client-side EGC process (e.g., client-side EGC processes 12, 14, 16, 18) is executed, namely client electronic devices 28, 30, 32, 34, for example. Users 44, 46, 48, 50 may access server-side EGC process 10 directly through network 22 and/or through secondary network 26. Further, server computer 20 (i.e., the computer that executes server-side EGC process 10) may be in communication with network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing a wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and personal digital assistants to be interconnected using a short-range wireless connection.

### Electronic Game Credit (EGC) Process

For the following discussion, server-side EGC process 10 will be described for illustrative purposes. It should be noted that server-side EGC process 10 may interact with client-side EGC process 12 and may be executed within one or more applications that allow for communication with client-side EGC process 12. However, this is not intended to be a limitation of this disclosure, as other configurations are possible (e.g., stand-alone, client-side EGC processes and/or stand-alone server-side EGC processes). For example, some implementations may include one or more of client-side EGC processes 12, 14, 16, and/or 18 in place of or in addition to server-side EGC process 10.

The methods and systems described in the present disclosure may be implemented to provide electronic game credit for an electronic game application in response to detecting completion of a task.

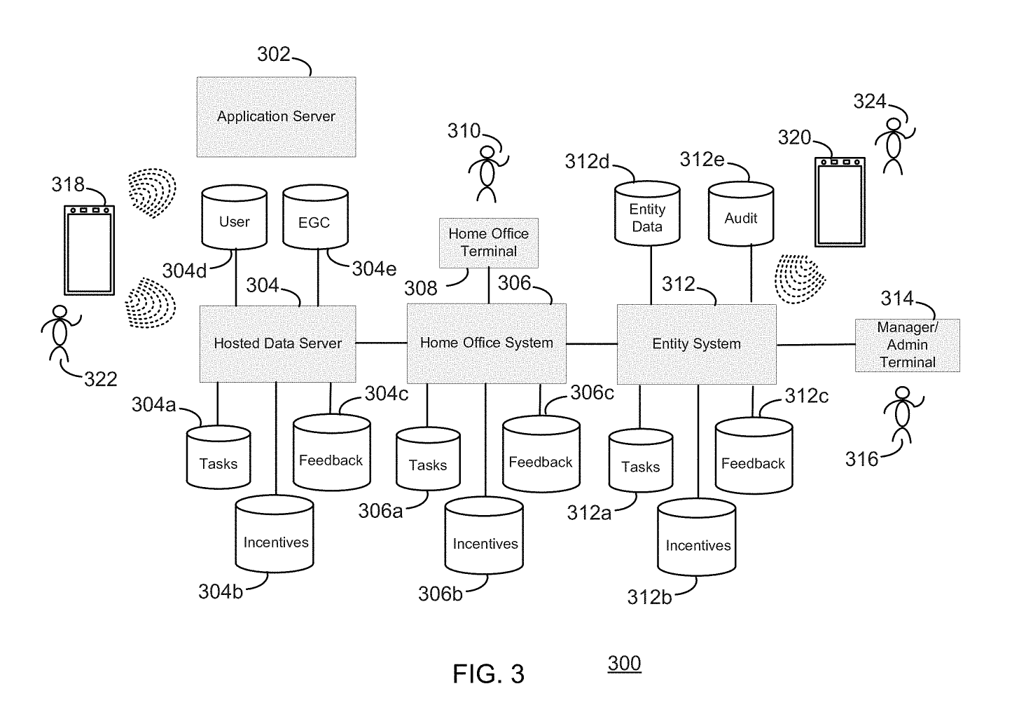

Referring now to FIG. 3, a system 300 for providing electronic game credit for an electronic game application in response to detecting completion of a task is shown. An application server 302 may provide an electronic game in which electronic game credit can be used. A hosted data server 304 may store and make accessible a variety of data regarding users, electronic game credit, tasks, incentives, and feedback. For example hosted data server 304 may use storage devices or databases 304a-304e to store task data, incentive data, feedback data, user data, and electronic game credit data, respectively. System 300 may also include a home office system 306 which may be used by a home office associate or administrator 310 and accessed via home office terminal 308. Home office system 306 may use storage devices or databases 306a-c to store task data, incentive data, and feedback data, respectively. System 300 may further include entity system 312, which may be a server system used by an entity such as a retail store. Entity system 312 may use storage devices or databases 312a-312e to store task data, incentive data, feedback data, entity data, and audit data, respectively.

System 300 may additionally include a manager or administrator terminal 314 which may be used by a manager or administrator 316 to access entity system 312. In an implementation, system 300 may include mobile devices 318 and 320. Mobile device 318 may be used by an associate, customer, or other user receiving electronic game credit for an electronic game application in response to detecting completion of a task. Mobile device 318 may be a personal device for the associate, customer, or other user 322 and may be or may be similar to any of client electronic devices 30, 32, and/or 34. Further, mobile device 320 may be an entity mobile or handheld device used by an associate 324 (e.g., an employee) of the entity while the associate works or completes tasks at the entity location (e.g., a retail store). Any of application server 302, hosted data server 304, home office system 306, and entity system 312 may be or may be similar to server computer 20. Further, any of home office system 306, home office terminal 308, and manager or administrator terminal 314 may be or may be similar to any of client electronic devices 28, 30, 32, and/or 34.

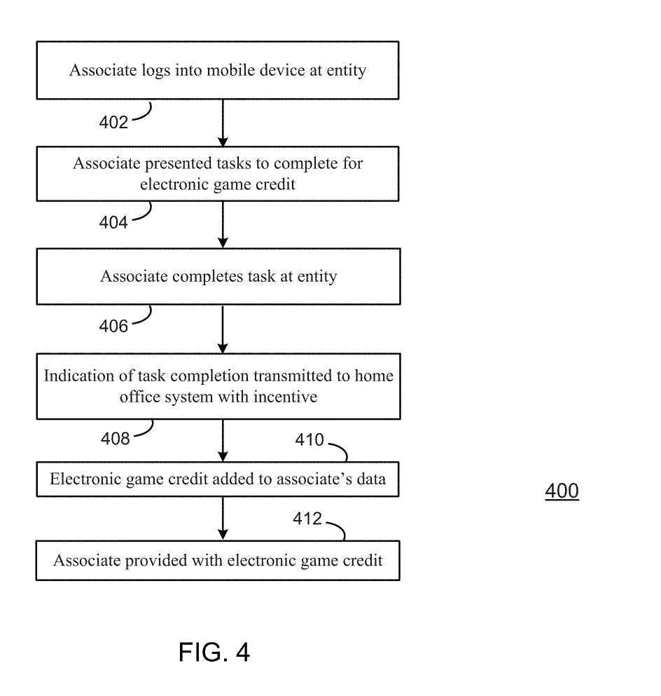

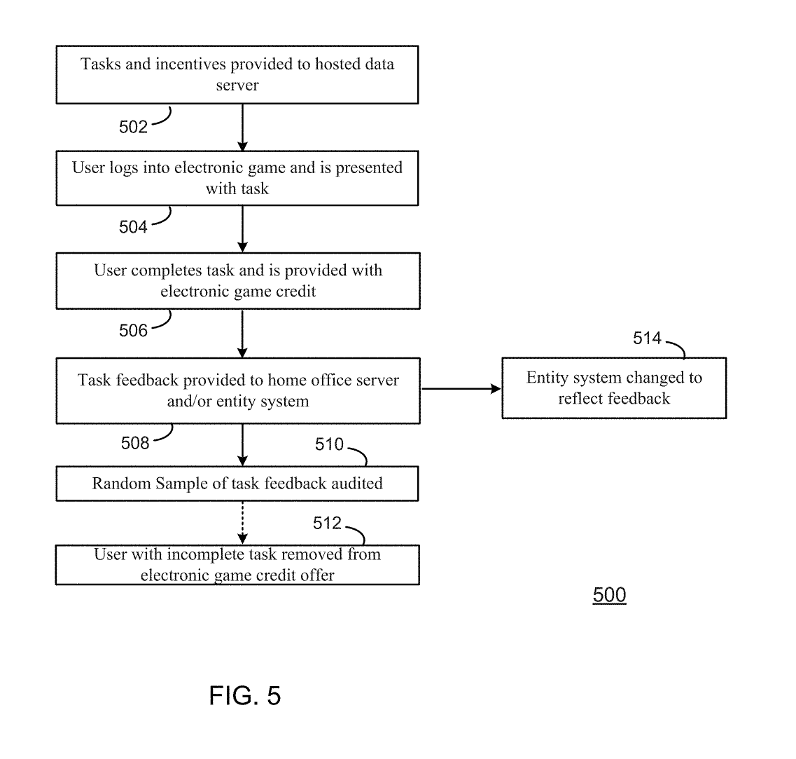

Referring to FIGS. 1 and 2, in an embodiment, methods for providing electronic game credit for an electronic game application in response to detecting completion of a task may be provided and may be implemented via EGC process 10. EGC process 10 may run on or may be executed by server computer 20 or entity system 312, as shown in FIG. 3. Referring now also to FIGS. 4 and 5, processes 400 and 500 are shown, respectively. Process 400 may be used to provide electronic game credit for an electronic game application in response to detecting completion of a task by an associate or employee or an entity (e.g., a retail store). Process 500 may be used to provide electronic game credit for an electronic game application in response to detecting completion of a task by another user such as a customer of the entity (e.g., a retail store). In an implementation, some or all of the operations shown in processes 400 and/or 500 may be facilitated by, executed by, or run on one or more of server computer 20, client electronic devices 28, 30, 32, and/or 34, application server 302, hosted data server 304, home office system 306, home office terminal 308, entity system 312, and/or manager or administrator terminal 314. Additionally, in an implementation, processes 400 and/or 500 may be part of or facilitated by EGC processes 10, 12, 14, 16, and/or 18.

In an embodiment, methods for providing electronic game credit for an electronic game application in response to detecting completion of a task may be implemented via EGC process 10. EGC process 10 may determine 202, at an entity host device (e.g., entity system 312), that a mobile device (e.g., mobile device 318) corresponding to a user (e.g., user 322) is present at an entity location. The entity location may be a company or business location such as a retail store or distribution center where the entity wants to incentivize completion of tasks. The user may be an employee, associate, customer, or other user of the entity who may not be an employee, associate, customer. For example, the user may be at least one of a retail store associate and a retail store customer. The tasks may be at least one of retail store tasks and distribution center tasks. In an implementation, the user may log 402 into the mobile device (e.g., mobile device 318 or 320) at the entity (e.g., retail store). The user may also log 504 into an electronic game for which electronic game credit can be provided and may be presented with one or more tasks.

Further, EGC process 10 may transmit 204, from the entity host device (e.g., entity system 312) to the mobile device (e.g., mobile device 318) at the entity location, the task for the user to complete at the entity location. The tasks may include but are not limited to inventory tasks, back room tasks, moving products, noting that products are running low or sold out on store shelves or racks (e.g., by taking a photo), and/or shifting products on shelves or racks (i.e., moving products closer to the front of the shelves or racks). Inventory tasks and back room tasks may be ideal for associates or employees of the entity because they may be permitted greater access to areas where those tasks can be completed. Other tasks where access to private areas of the entity is not required may be more suitable for customers or other users.

For example, a customer may take photographs (e.g., via a mobile device) of products in promotional spots (e.g., places where more people walk in a retail store which may be referred to as an action alley) as a task. The promotional spots may include pallets, bins, or shelves of various merchandise. The entity system or home office system may identify a location of the promotional spot, analyze what product is actually at the promotional spot, analyze for price, verify that a promotional sign is there, and/or correlate location of the device to the location where the photograph was taken. The entity system or home office system may also use the photograph taken to run video analytics on the promotional spot at a later time. Other tasks may include taking photographs of different items throughout a retail store and finding items in the store if the store management does not know where particular items are (e.g., as indicated by lower sales, unexpected sales without having an item location, etc.). The entity system may receive the photograph and correlate a location of the mobile device with the photograph. Another task may be a sequencing task to help identify location information in a referential location system including defined zones and aisles where it is unknown which zones and aisles are opposite or adjacent to each other. For this task, the customer may take photographs or bar code scans throughout store and analytics may be used to determine more specific location information about the zones and aisles from there.

Additional tasks may include pricing compliance tasks to verify whether shelf-labeled prices are correct to corresponding products. Customers may take photographs and bar code scans, manually enter prices, etc., and analytics may be performed to determine if the prices are correct. For example, if the retail store was supposed to have a number of price changes, a customer may perform tasks (e.g. take photos) to determine if store workers properly changed the prices. Customers may also perform tasks such as collecting stray shopping carts and bringing them to a shopping cart collection area, finding bad produce and taking photographs, finding dead plants in a garden area and taking photographs, etc.

Further, a user 324, who may be a retail store associate, may use an entity-issued mobile device 320 while working at the entity, which may be a retail store. The retail store associate may move about the entity (e.g., a retail store) with the entity-issued mobile device 320, which may display the list of tasks for the retail store associate to complete at the retail store. The list of tasks may also include corresponding electronic game credit which may be received for performing one or more of the tasks. The list of tasks and corresponding incentives or electronic game credit may also be provided 502 to the hosted data server 304, which may provide the tasks and incentives to mobile devices corresponding to users. In this way, the associate may be presented 404 tasks to complete for electronic game credit. In an implementation an associate or customer of the retail store or other entity may receive and view the task list and corresponding electronic game credit via personal mobile device 318, which may not be an entity-issued mobile device. Completion of a retail store task by a retail store customer at a retail store location may offload one or more retail store tasks from a retail store associate task list (which may be viewed, e.g., via entity-issued mobile device 320).

Further, the user may complete 406 the task at the entity. EGC process 10 may also include detecting 206, at the entity host device (e.g., entity system 312), that the user has completed the task at the entity location. Detecting that the user has completed the task may include receiving (e.g., at the entity system 312) a photograph of the task completion, an indication or message from the user or a manager or administrator that the task has been completed, or other verification that the task has been completed.

In an implementation tasks completion may be verified in a number of ways. For example, multiple customers or associates may perform the same task and any task artifacts (e.g., photographs, bar code scans, location tag identifications, data collected, etc.) may be used for comparison purposes to verify that the task was completed properly. For example, if a customer or associate takes a photograph of a feature item in an action alley or promotional spot, the entity system or home office system may verify that the customer or associate was at the location with mobile device-based location data. Further, analytics may be used to determine if the photograph of a product and price are not the same as in another photograph of a product and price recently received to make sure that the same photograph taken by the same user was not sent from different devices. Additionally, an associate may audit a subset of customer tasks to determine that the customer completed the task properly. Further, associates may verify that customer tasks were performed correctly by entering a code into the customer's mobile device or taking photographs with the associate's badge and the customer. EGC process 10 may transmit 408 an indication that the task was completed to home office system 306 and may include an indication of the corresponding incentive or electronic game credit to be provided.

The user may complete the task and may be provided 506 the corresponding electronic game credit. Further, EGC process 10 may, in response to detecting that the user has completed the task at the entity location, assign 208, at the entity host device (e.g., at the entity system 312), electronic game credit to an electronic game credit record corresponding to the user. For example, entity system 312 may receive (via, e.g., EGC process 10) an indication that the task has been completed and may change a status for the task in tasks storage or database 312a and add electronic game credit to an electronic game credit record corresponding to the user in incentives storage or database 312b. As a result, a record corresponding to the task in tasks storage or database 312a may reflect that the task is completed and the electronic game credit record corresponding to the user incentives storage or database 312b may reflect that the user gained an amount of electronic game credit corresponding to the task. In this way, EGC process 10 may add 410 the electronic game credit to data corresponding to the user and the user may be provided 412 with the electronic game credit.

As described above, the electronic game credit may be used in an electronic game. In order to facilitate use of the electronic game credit in the electronic game, EGC process 10 may link 210 an entity user ID corresponding to the user with an electronic game application ID corresponding to the user. The entity user ID may be assigned to the user by the entity and may be related to an account that the user has with the entity. In the case of an employee or associate, the entity user ID may be related to the employee or associate's employment. The electronic game application ID may be provided by the electronic game application developer or provider, and may be related to the user's account with the electronic game application developer or provider.

In an implementation, an associate and/or customer may register with the entity for an electronic game credit program and obtain a sign-in or log-in ID (i.e., entity user ID) and identify which electronic games they are interested in. The entity system may correlate the entity user ID to the electronic game that associate or customer is interested in. A third party, such as an application developer or provider (e.g., Apple, Google, etc.) may also have a user ID for the associate or customer (e.g., electronic game application ID), and the entity system may correlate the entity user ID and the electronic game application ID. The entity may transmit the credit from the entity system through an API to a record corresponding to the electronic game application ID administered by the third party. The credit may work on a PC game, mobile device game, etc. Correlation and linking between the entity user ID and the electronic game application ID may be administered through a database associated with the entity. In an implementation, once the task has been verified as completed, EGC process 10 may perform an API call from the entity system to the third party system to transmit the proper amount of electronic game credit for the identified electronic game.

EGC process 10 may also transmit 212 the electronic game credit in the electronic game credit record from the entity host device (e.g., entity system 312) to an electronic game application host server (e.g., application server 302 or hosted data server 304) associated with the electronic game application based on the linking of the entity user ID and the electronic game application ID. For example, hosted data server 304 may receive the electronic game credit and may store and/or make accessible the electronic game credit in electronic game credit storage or database 304e. Application server 302, which may host the electronic game application and may be administered by the electronic game developer or provider, may access the electronic game credit from electronic game credit storage or database 304e and apply the electronic game credit for use by the user in the electronic game.

In an implementation, the electronic game credit in the electronic game credit record may be transmitted from the entity host device (e.g., entity system 312) to the electronic game application host server (e.g., application server 302 and/or hosted data server 304) in response to detecting that the mobile device (e.g., mobile device 318) corresponding to the user is no longer present at the entity location. For example, the entity location may be a retail store and the user may be an associate who may be an employee of the retail store or a customer of the retail store. EGC process 10 may detect, via location-based services (GPS), Wi-Fi, or other protocols or signals, that a mobile device corresponding to the user is no longer present at the retail store. EGC process 10 may transmit the electronic game credit in the electronic game credit record to the electronic game application host server at this time, in part, so that the associate does use the electronic game credit to play the electronic game at the store.

The electronic game may be accessed by the user and may be played by the user on mobile device 318, or one or more of client electronic devices 28, 30, 32, and/or 34. In an implementation, EGC process 10 may include transmitting 214 from the entity host device (e.g., entity system 312) to the electronic game application host server (e.g., application server 302 or hosted data server 304), an electronic notification indicating that the user can receive electronic game credit for the electronic game application upon completing a task. For example, the user may access or play the electronic game on mobile device 318, or one or more of client electronic devices 28, 30, 32, and/or 34 and may receive the electronic notification either while playing the electronic game, as a notification received via an operating system of the mobile device or one or more of client electronic devices 28, 30, 32, and/or 34, as a text message, or as an email.

In an implementation, the entity host device may be at least one of an entity host server (e.g., entity system 312) and a home office device (e.g., home office system 306). Home office system 306 may be accessed by a home office associate 310 via a home office terminal 308. Further, the electronic game credit may be an incentive defined via at least one of the entity host server (e.g., entity system 312) and the home office device (e.g., home office system 306, via, for example, home office terminal 308). The incentive may be created to prioritize one or more tasks. For example, there may be a number of tasks at the entity that need attention and employees or associates may not have time to complete the tasks or may not prioritize the tasks for a number of reasons. By providing electronic game credit to the associate or employee (or customer) for completing the task, or by providing more electronic game credit for some tasks than others, the entity may prioritize certain tasks for associates or employees.

Further, EGC process 10 may receive 216 an electronic game preference from the user identifying an electronic game application preferred by the user for which the electronic game credit is assigned. The electronic game preference may be received at entity system 312 such that EGC process 10 can identify one or more preferred electronic games of the user and provide electronic game credit to the user for the preferred electronic games. In an implementation, an associate or customer may select preferred electronic games from a list which may be provided via mobile device 318.

In some situations, it may be questionable whether the user (e.g., associate, employee, or customer) actually completed the task before electronic game credit was provided to the user. For example, the user may indicate (via, e.g., mobile device 318) that the task was completed in order to get the electronic game credit, but the user may not have actually completed the corresponding task. In an implementation, EGC process 10 may audit 218 a random sample of electronic game credits assigned to users to ensure that tasks for which the electronic game credits were assigned were completed. For example, EGC process 10 may compare 220 results from a same task completed by different users to determine if the task was actually completed. Comparing the results may include verifying that the same photograph was not received at different retail stores associated with the entity to prevent, for example, a situation where one person emails the photograph to all their friends and each submits the photograph to a different entity location. In an implementation, auditing of customer tasks may be performed through an associate, auditing of associate tasks may be performed through a customer, auditing of customer tasks may be performed through other customers, or various combinations of associate and customer task auditing may be performed.

Task feedback may be provided 508 to home office server or system 306 and/or entity system 312. One or more records in the home office server or system 306 and/or entity system 312 may be changed 514 to reflect the feedback. The task feedback or a random sample of the task feedback may be audited 510 via, e.g., EGC process 10 in an automated manner or by an administrator, manager, or home office associate to determine if tasks were actually completed. In response to determining that the task was not completed, EGC process 10 may remove 222 the user from the electronic game credit program and the user with an incomplete task may no longer be offered 512 electronic game credit for completing tasks.

As described above, the techniques and features described in the present disclosure may facilitate electronic customer savings redemption from an electronic customer savings account or savings catcher account associated with a customer. Using the techniques and features described in the present disclosure, the retailer may implement a system for facilitating electronic customer savings redemption from the electronic customer savings account associated with the customer.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer-readable medium for execution by, or to control the operation of, a data processing apparatus. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions or computer program products and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These may also be referred to as computer-readable storage media. The processor and the memory can be supplemented by, or incorporated in, special purpose logic circuitry.

To provide for interaction with a user, implementations of described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

A number of embodiments and implementations have been described. Nevertheless, it will be understood that various modifications may be made. Accordingly, other embodiments and implementations are within the scope of the following claims. For example, the actions recited in the claims can be performed in a different order and still achieve desirable results.

What is claimed is:

1. A method for providing electronic game credit for an electronic game application in response to detecting completion of a task, the method comprising:
determining, at an entity host device, that a mobile device corresponding to a user is present at an entity location;
transmitting, from the entity host device to the mobile device at the entity location, the task for the user to complete at the entity location;
detecting, at the entity host device, that the user has completed the task at the entity location;
in response to detecting that the user has completed the task at the entity location, assigning, at the entity host device, the electronic game credit to an electronic game credit record corresponding to the user;
linking an entity user ID corresponding to the user with an electronic game application ID corresponding to the user; and
transmitting the electronic game credit in the electronic game credit record from the entity host device to an electronic game application host server associated with the electronic game application based on the linking of the entity user ID and the electronic game application ID.

2. The method of claim 1, further comprising:
transmitting, from the entity host device to the electronic game application host server, an electronic notification indicating that the user can receive electronic game credit for the electronic game application upon completing the task.

3. The method of claim 1, wherein the electronic game credit in the electronic game credit record is transmitted from the entity host device to the electronic game application host server in response to detecting that the mobile device corresponding to the user is no longer present at the entity location.

4. The method of claim 1, wherein the entity host device is at least one of an entity host server and a home office device and the electronic game credit is an incentive defined via at least one of the entity host server and the home office device.

5. The method of claim 4, wherein the incentive is created to prioritize the task.

6. The method of claim 1, further comprising:
receiving an electronic game preference from the user identifying an electronic game application preferred by the user for which the electronic game credit is assigned in response to detecting that the user has completed the task at the entity location.

7. The method of claim 1, further comprising:
auditing a random sample of electronic game credits assigned to users to ensure that tasks for which the electronic game credits were assigned were completed.

8. The method of claim 1, further comprising:
in response to determining that the task was not completed, removing the user from an electronic game credit program.

9. The method of claim 1, further comprising:
comparing results from a same task completed by different users to determine if the task was actually completed.

10. The method of claim 1, wherein the entity location is at least one of a retail store location and a distribution center and the task is at least one of a retail store task and a distribution center task.

11. The method of claim 10, wherein the user is at least one of a retail store associate and a retail store customer.

12. The method of claim 11, wherein the completion of the retail store task by the retail store customer at the retail store location offloads the retail store task from a retail store associate task list.

13. A system for providing electronic game credit for an electronic game application in response to detecting completion of a task, the system comprising:
an entity host device in communication with a mobile device corresponding to a user configured to:
determine whether the mobile device corresponding to the user is present at an entity location;
transmit, to the mobile device at the entity location, the task for the user to complete at the entity location;
detect, at the entity host device, that the user has completed the task at the entity location;
in response to detecting that the user has completed the task at the entity location, assign the electronic game credit to an electronic game credit record corresponding to the user;
link an entity user ID corresponding to the user with an electronic game application ID corresponding to the user; and
transmit the electronic game credit in the electronic game credit record to an electronic game application host server associated with the electronic game application based on the linking of the entity user ID and the electronic game application ID.

14. The system of claim 13, wherein the entity host device is further configured to:
transmit, to the electronic game application host server, an electronic notification indicating that the user can receive electronic game credit for the electronic game application upon completing the task.

15. The system of claim 13, wherein the electronic game credit in the electronic game credit record is transmitted from the entity host device to the electronic game application host server in response to detecting that the mobile device corresponding to the user is no longer present at the entity location.

16. The system of claim 13, wherein the entity host device is at least one of an entity host server and a home office device and the electronic game credit is an incentive defined via at least one of the entity host server and the home office device.

17. The system of claim 13, wherein the incentive is created to prioritize the task.

18. The system of claim 13, wherein the entity host device is further configured to:
receive an electronic game preference from the user identifying an electronic game application preferred by the user for which the electronic game credit is assigned in response to detecting that the user has completed the task at the entity location.

19. The system of claim 13, wherein the entity host device is further configured to:
audit a random sample of electronic game credits assigned to users to ensure that tasks for which the electronic game credits were assigned were completed.

20. A computing system for providing electronic game credit for an electronic game application in response to detecting completion of a task, the computing system comprising one or more processors, wherein the one or more processors are configured to:
determine, at an entity host device, that a mobile device corresponding to a user is present at an entity location;
transmit, from the entity host device to the mobile device at the entity location, the task for the user to complete at the entity location;
detect, at the entity host device, that the user has completed the task at the entity location;
in response to detecting that the user has completed the task at the entity location, assign, at the entity host device, the electronic game credit to an electronic game credit record corresponding to the user;
link an entity user ID corresponding to the user with an electronic game application ID corresponding to the user; and
transmit the electronic game credit in the electronic game credit record from the entity host device to an electronic game application host server associated with the electronic game application based on the linking of the entity user ID and the electronic game application ID.
